(19) United States
(12) Patent Application Publication
(10) Pub. No.: US 2021/0301800 A1
(43) Pub. Date: Sep. 30, 2021

(54) DEVICE AND METHOD FOR RELOCATING WATER

(71) Applicant: Ocean-Based Climate Solutions, Inc., Santa Fe, NM (US)

(72) Inventor: Philip Kithil, Santa Fe, NM (US)

(21) Appl. No.: 17/267,200

(22) PCT Filed: Aug. 13, 2019
(86) PCT No.: PCT/US2019/046292

§ 371 Date: Feb. 9, 2021

Related U.S. Application Data
(60) Provisional application No. 62/719,551, filed on Aug. 17, 2018.
(60) Provisional application No. 62/752,020, filed on Oct. 29, 2018.

(51) Int. Cl. F04B 17/00; F03B 13/20

(52) U.S. Cl. CPC F04B 17/00; F03B 13/20

(57) ABSTRACT

A water relocation device comprising one or more flexible water conduits, wherein the one or more conduits are arranged circumferentially around an operating element of the water relocation device, and a method of increasing ocean carbon sink comprising creating a plurality of parcels of salt and distributing the salt parcels on an ocean surface.

### CROSS-REFERENCE TO RELATED APPLICATIONS

This application claims priority to U.S. Provisional Patent Application Ser. No. 62/719,551, filed on Aug. 17, 2018, and to U.S. Provisional Patent Application Ser. No. 62/752,020, filed on Oct. 29, 2018.

### STATEMENT REGARDING FEDERALLY SPONSORED RESEARCH OR DEVELOPMENT

Not Applicable.

### NAMES OF PARTIES TO JOINT RESEARCH AGREEMENT

Not Applicable.

### REFERENCE TO A SEQUENCE LISTING, A TABLE, OR A COMPUTER PROGRAM LISTING COMPACT DISC APPENDIX

Not Applicable.

### STATEMENT REGARDING PRIOR DISCLOSURES BY THE INVENTOR OR A JOINT INVENTOR

Not Applicable.

### BACKGROUND OF THE INVENTION

### Field of the Invention (Technical Field)

The present invention relates to a method, substance, and apparatus for relocating water and for making ocean water denser.

### Description of Related Art

The ocean is comprised of numerous parcels of sea water which at any moment in time are neutrally-buoyant, that is, fixed relative to the center of earth. However, over successive time periods, these parcels often are moving relative to center of earth. Upward-moving is termed “upwelling”, and downward-moving is termed “downwelling”. Upwelling and downwelling may be caused by changes in the water parcel's temperature (from sunlight), and/or salinity (from evaporation) relative to adjacent parcels, and/or by changes imposed by surface winds, ocean currents, subsea earthquakes, subsea topography, earth rotation (the Coriolis effect), river outflow, or other physical forces.

On average, the ocean contains about 3.5% dissolved salt mostly in the form of sodium chloride (“table salt”). At any given water temperature, water parcel density (and therefore its location relative to center of earth) of the water parcel is substantially determined by its salt content. Downwelling of a water parcel (leaving aside the physical forces mentioned above), can occur either by the temperature decreasing and/or the salt content increasing. This invention describes a method and substance which can increase the salt content, increasing density and thereby causing downwelling.

Atmospheric CO2 is known as a greenhouse gas because it absorbs reflected sunlight. The amount of CO2 in the atmosphere, prior to advent of fossil fuel use, was about 280 parts per million (ppm), but since the industrial revolution has climbed above 410 ppm. During the pre-industrial era, earth's average temperature was relatively constant, but with higher levels of atmospheric CO2, the average has increased. This is now causing environmental changes that create existential risks to mankind—sea-level rise from melting icecaps and glaciers, drought and fires, changes to agricultural production from heat waves, etc.

The oceans currently absorb about half of mankind's annual CO2 emissions into the atmosphere, in the form of dissolved CO2. Downwelling is one of the primary mechanisms for moving upper ocean water parcels containing this CO2 to the deep ocean where it is removed from contact with the atmosphere for decades if not centuries. A comprehensive scientific treatment of density-driven downwelling can be found in Dr. Timour Radko's book “Double-Diffusive Convection” published in 2013 by Cambridge University Press (ISBN 978-0-521-88074-9). As stated in the Preface, “Double-diffusion operates in a counterintuitive way; it is a mixing process that makes dense fluid denser and light fluid lighter. It is driven by the difference in molecular diffusivities of heat and salt . . . ” Further discussion specifies these differences (p4): “ . . . the two orders of magnitude difference between the molecular diffusivities of density components: kₜ˜1.4×10⁻⁷ m² s⁻¹ for temperature and kₛ˜1.1×10⁻⁹ m² s⁻¹ for salt.”

### BRIEF SUMMARY OF THE INVENTION

The present invention is of a water relocation device comprising one or more flexible water conduits, wherein the one or more conduits are arranged circumferentially around an operating element of the water relocation device. One can employ two or more flexible water conduits attached in the lengthwise direction, wherein an attachment optionally is provided with elongation control elements. One can also employ multiple floatation components, in which the shape of the combined floatation components is cylindrical for shipment and separates into a non-cylindrical shape after release onto a body of water and/or in which the shape of the device is cylindrical with a longitudinally-centered center of gravity during shipment and whose shape is depthwise upon deployment onto a body of water. One can further employ two or more valves, the valves operating on different wave movements.

The present invention is also of a method of increasing ocean carbon sink comprising the steps of: creating a plurality of parcels of salt; and distributing the salt parcels on an ocean surface. In an embodiment, the salt parcels are neutrally-buoyant in the upper ocean, are configured to dissolve at a controlled rate, taking into account the ambient ocean conditions where the salt parcels are distributed, are configured with additional mineral and/or chemical constituents to modify ocean pH, and/or are configured with mineral, chemical, and/or nutrient constituents to modify ocean productivity. The method performs best when the ocean surface is located between about 50° North and 50° South latitudes.

The invention is further of an exchange process whereby a CO2 emitting entity contracts with a CO2 removal entity to remove CO2, and exchanges ownership proportional to the amount of CO2 removed. In an embodiment, the CO2 removal entity employs ocean processes to accomplish the CO2 removal, such as downwelling, including wherein downwelling modifies ocean temperature, pH, and/or salinity.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a side view of a deployed device according to the invention;

FIG. 2 is an end view of the device during deployment;

FIG. 3 provides a view of the multi-part floats prior to deployment; and

FIG. 4 shows the floats and valve during deployment.

### DETAILED DESCRIPTION OF THE INVENTION

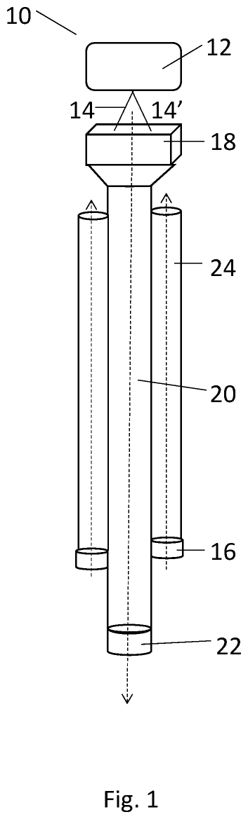

The present invention is of a device and method for relocating water, the device preferably powered by renewable energy, which preferably is wave energy. The device is designed to deploy automatically when placed on the surface of a body of water. This is achieved by arranging the working elements, namely floatation, valves, and flexible tubes, such that they are provided a cylindrical shape for shipment and during placement on the body of water, and then automatically assume a depthwise shape after placement. The energy source for the automatic change in shape is gravity. The device further comprises opposing relocation directions of the water being relocated. The device extracts and makes use of energy both from the upslope and downslope wave surface. To accomplish this dual-direction feature, the device 10 is provided with fabric tubes 20,24 whose water outlets are opposite, as shown in FIG. 1. The one or more tubes which relocate water upward contain structural elements such as fiberglass webbing in the depthwise direction, which reduce elongation of the fabric tube when the corresponding valve is closed. The device further comprises multi-part float 12, ropes 14,14′, downwelling valve 18, upwelling valves 16, and bottom weight 22.

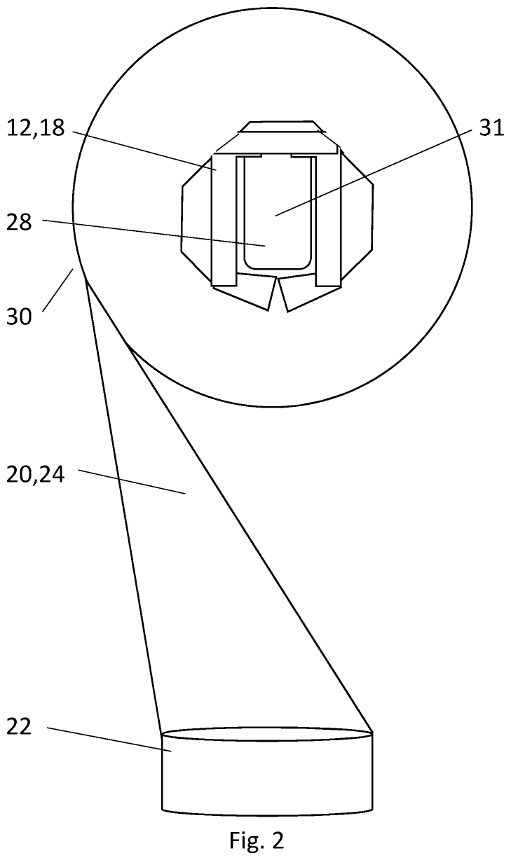

The floatation and valve working elements are designed so that the cylinder's lengthwise center of gravity is substantially at the geometric center of the cylinder during shipment and during placement on the body of water, as shown in FIG. 2. The device comprises tubes 20,24 fabricated from a flexible material such as nylon or polyester fabric. The tubes are wrapped circumferentially 30 around the floatation and valve working elements 12,18, with the top end of the downwelling tube 20 secured to the downwelling valve and the other end to a bottom weight 22. Upon placement on a body of water, the weight sinks and unspools the fabric tubes from the cylinder. The downwelling valve is connected by ropes 14,14′ to the floatation apparatus 12. FIG. 2 shows the approximate center of gravity 31 of the apparatus in this configuration.

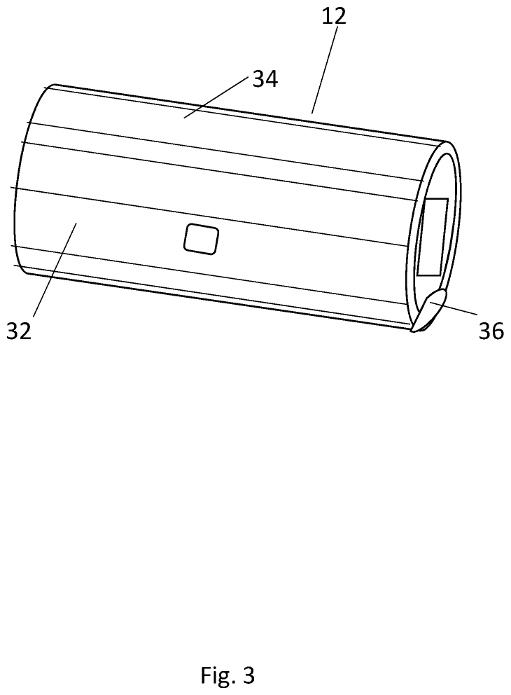

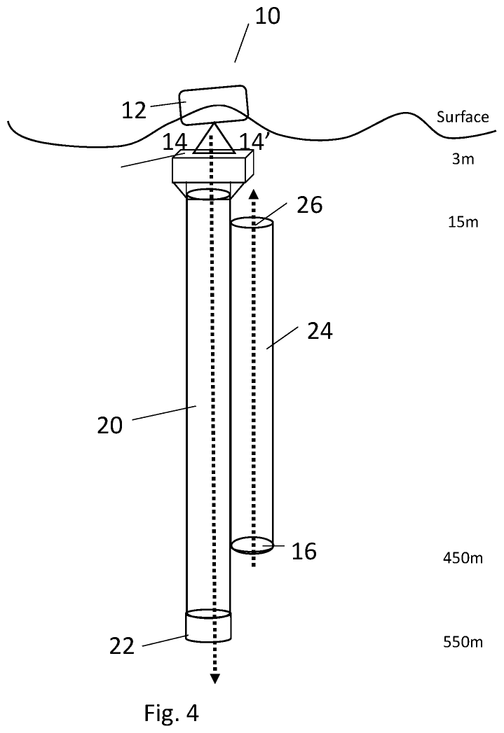

When the fabric tube has fully unspooled, it releases a catch holding the valve and multi-part floats together in cylindrical shape 12, as shown in FIG. 3. This embodiment of the floats comprises main float 32, secondary float 34, and auxiliary floats 36. Upon release, the floats separate from the valve and assume a position on the water surface where they rise and fall with passing waves. Since the floats and valve are attached this causes the upper valve to rise and fall, which activates the valve panels to open and close, forcing water inside the valve into and down the tube to the bottom weight, where the water exits and mixes with adjacent water, as shown in FIG. 4.

Additionally, the rising and falling of the floats cause the valves attached at the bottom of the upwelling tubes to close and open, forcing water upward inside the tubes. The direction of force applied to the upwelling valves is thus opposite from the direction of force applied to the downwelling valve.

The tubes which are not connected to the upper valve are secured edgewise to the tube which is connected to the upper valve. Each of these tubes is provided with a lower valve. The edgewise securing may include material with very low elongation, such as fiberglass or carbon fiber webbing. By controlling the elongation of the edgewise securing, the up and down movement of the floatation on passing waves is substantially transmitted to these lower valves, which as mentioned work in opposition to the upper valve.

To implement the floatation so it can assume a cylindrical shape for shipment, it is divided into multiple lengthwise partial cylinders which nest together against the upper valve. When nested together, the combined center of gravity of the lengthwise floatation components and the upper valve are substantially at the geometric lengthwise center of the entire unit.

This enables spooling of the fabric tubes onto the cylinder without changing the fully assembled unit's center of gravity.

The upwelling valves are fabricated to lie substantially flat against the cylinder when spooled onto the cylinder. To further improve the weight and balance, the tubes to which the upwelling valves are attached may be different lengths so these valves lie against opposite sides of the cylinder, when it is fully spooled.

Once deployed, as shown in FIG. 4, the tubes with lower valves bring up water from depth (“upwelling”), and the tube with upper valve sends upper water downward (“downwelling”). The upper ends of the upwelling tubes are open and at a level somewhat below the inlet of the upper valve. Since this upwelled water is colder, it is denser and sinks as it mixes into the upper ocean while remaining above the thermocline. This upwelled water also contains nutrients which can trigger photosynthesis to absorb dissolved CO2 and emit oxygen. Multiple benefits are thus derived from upwelling: cooling the upper ocean, absorbing dissolved CO2, emitting oxygen, and triggering growth of phytoplankton which support higher trophic levels.

The downwelled water relocates ocean heat to depth while amplifying downward movement of particulate organic carbon resulting from the phytoplankton life cycle. Other carbon components such as dissolved CO2 and dissolved organic carbon (DOC) also will be sent downward, to further amplify the net carbon exported to depth.

The downwelling process itself can be amplified if the water inside the tube cools so that it becomes more dense than adjacent water outside the tube. This density gradient becomes more pronounced since the water inside the tube contains salt levels found in the water entering the upper valve inlet. Since salt makes water denser, this is known as the salt fountain effect.

An alternative and more direct process includes adding salt to the surface ocean to create the density gradient and enhance the downwelling of upper ocean waters containing the elevated levels of CO2.

Several attributes are preferable to make this salt-additive process effective. First, there must be widespread dispersal of salt parcels on suitable locations of the ocean surface. Radko among others specifies the tropical, subtropical, and mid-latitude oceans between 50° North and 50° South latitudes as suitable regions, due to prevailing upper ocean warmth and higher salinity, compared to the sub-Polar and Polar (Arctic and Antarctic) ocean regions which tend to be colder and lower salinity. Second, the salt parcels must be in a form that dissolves at a controlled rate, to optimize the volume of downwelling. If the salt dissolves too quickly, the volume of induced downwelling may restricted to local water parcels; and if the salt dissolves too slowly, the additional density may be advected and limit the downwelling. Third, the salt parcels must be neutrally-buoyant in the upper ocean. This could be accomplished by embedding air bubbles or equivalent floatation components in the salt parcel. Otherwise, the salt parcel could quickly sink to the seafloor before it dissolves, reducing or eliminating the diffusive effect.

While NaCl is an abundant salt useful with the invention, other non-toxic salts native to seawater could be used. While the size and spacing of salt parcels can vary according to ambient conditions, salt parcels of about one cubic meter applied per square kilometer (assuming dissolution occurs in the top 10 meters, this being 0.1% ratio) provides good results. The dissolution rate then determines how often new salt parcels are added to maintain the downwelling from salinity density.

Optionally, the salt parcel could also contain minerals and/or nutrients to counteract some of the negative impacts from mankind's excess CO2 dissolving into the oceans. In one instance, excess CO2 dissolving into the ocean reacts chemically to reduce the ocean pH, making the ocean more acidic. Adding a non-toxic base component to the salt parcel could help offset this impact and increase ocean pH.

In another instance, one impact of climate change is warming of the upper ocean which reinforces stratification, in turn limiting nutrients needed to support primary production. Selectively adding appropriate nutrients to the salt parcel could help mitigate this issue.

Overall, the global community has not yet fully developed social and economic policies dealing with mankind's excess CO2 emissions. Despite the successful outcome to the 2015 UN meeting in Paris which saw nearly all countries agree to limit future CO2 emissions (“The Paris Accord”), recent data suggest only 14% of mankind's excess CO2 emissions come under some form of limitation, such as a price on carbon, cap and trade, emissions trading systems, etc. The reasons for slow adoption are numerous, but have been succinctly stated by the Climate Leadership Council as found at their website www.cicouncil.org/why-climate-progress-is-deadlocked.

Lack of Short-Term Benefits. It is inherently difficult to persuade individuals or nations to incur short-term costs now for benefits that will accrue to others 30 years or more in the future. Indeed, this runs contrary to human nature; considerable behavioral research suggests that people have a strong preference for avoiding short-term pain even if it is for long-term gain. Accordingly, solutions that rely primarily on sacrifice and deferred benefit are unlikely to succeed. This explains why carbon taxes are a difficult political sell, coming across as all sticks and no carrots. A winning climate strategy must offer tangible short-term benefits powerful enough to overcome the corresponding sacrifices.

The Free Rider Problem. Because the climate is a global commons, the benefits of emissions reductions undertaken in one country will mostly accrue outside its borders. As a result, countries acting in their rational self-interest are incentivized to minimize their mitigation efforts and free ride on those of others. This fundamental problem has constrained all past attempts to reach international climate agreements, including the recent Paris summit. The best solution is to design national climate programs in a manner that compels other countries to follow suit. The free rider problem also raises questions of climate fairness, given that many of the countries likely to suffer the most from climate change are typically those least responsible for emitting greenhouse gases.

False Tradeoffs. Climate progress is blocked not only by partisan divides, but also by false tradeoffs. Some advocates of renewable energy oppose nuclear power, even though both may be needed to combat climate change. Many environmentalists tend to be anti-corporate, even though any viable mitigation plan must rest in part on business leadership. The message of fear and austerity espoused by some on the green-left tends to alienate those at the opposite end of the political spectrum, who see climate policies as a Trojan horse for a bigger and more intrusive government. Many GOP leaders, meanwhile, deny basic science and fail to offer concrete solutions. We need fresh approaches able to bridge these divides.

Competing Agendas. The world lacks a shared or winning climate endgame. Even the most committed countries and regions are nowhere close to sufficiently reducing emissions, and have devoted much political capital to flawed strategies. For instance, many prefer to subsidize renewables rather than tax carbon. But this approach suffers from two design flaws: its costs increase as more renewables come online, and the subsidies do little to discourage consumption of power from existing fossil fuel plants. The European Union has devoted 13 years to an Emissions Trading System that has crashed twice and missed its objectives. There will never be a single climate solution. But we urgently need a common lever capable of delivering and inspiring a system-wide course correction. The ideal solution would be simple, popular, and replicable, yet ultimately far-reaching.

Accordingly, this invention further includes an exchange process, whereby entities which emit CO2 exchange value with entities which remove CO2. The value to be exchanged can be in the form of ownership in the entity which emits CO2, in proportion to the volume of CO2 removed. The entity removing CO2 receives the ownership either in advance of the CO2 removal event, during the removal event, or upon verification of the amount of CO2 it has removed; or some combination of advance, during, and upon CO2 removal verification. Further to this exchange process, an employer may retain the CO2 removing entity to remove CO2 emitted by its employees in their everyday life and provide rights to ownership in the employer, proportional to the total employees' CO2 removed. In one example, the US per capita CO2 emissions are about 16.5 tons whereas a sustainable lifestyle requires emissions of about 3 tons per year. Thus, the employer could retain the CO2 removal entity to remove 13.5 tons per year per employee, achieving net-zero per capita annual emissions for the employees, and pay the CO2 removing entity in ownership proportional to total employees' CO2 removed.

Note that in the specification and claims, “about” or “approximately” means within ten percent (10%) of the numerical amount cited.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. A water relocation device comprising one or more flexible water conduits, wherein the one or more conduits are arranged circumferentially around an operating element of the water relocation device.

2. The device of claim 1 comprising two or more flexible water conduits which are attached in the lengthwise direction, wherein an attachment optionally is provided with elongation control elements.

3. The device of claim 1 additionally comprising multiple floatation components, in which the shape of the combined floatation components is cylindrical for shipment and separates into a non-cylindrical shape after release onto a body of water.

4. The device of claim 1 whose shape is cylindrical with a longitudinally-centered center of gravity during shipment and whose shape is depthwise upon deployment onto a body of water.

5. The device of claim 1 additionally comprising two or more valves, said valves operating on different wave movements.

6. A method of increasing ocean carbon sink, the method comprising the steps of:
creating a plurality of parcels of salt; and
distributing the salt parcels on an ocean surface.

7. The method of claim 6 wherein the salt parcels are neutrally-buoyant in the upper ocean.

8. The method of claim 6 wherein the salt parcels are configured to dissolve at a controlled rate, taking into account the ambient ocean conditions where the salt parcels are distributed.

9. The method of claim 6 wherein the salt parcels are configured with additional mineral and/or chemical constituents to modify ocean pH.

10. The method of claim 6 wherein the salt parcels are configured with mineral, chemical, and/or nutrient constituents to modify ocean productivity.

11. The method of claim 6 wherein the ocean surface is located between about 50° North and 50° South latitudes.

12. An exchange process whereby a CO2 emitting entity contracts with a CO2 removal entity to remove CO2, and exchanges ownership proportional to the amount of CO2 removed.

13. The process of claim 12 wherein the CO2 removal entity employs ocean processes to accomplish the CO2 removal.

14. The process of claim 13 wherein the ocean processes comprise downwelling.

15. The process of claim 14 wherein downwelling modifies ocean temperature, pH, and/or salinity.

16. An exchange process whereby an employer contracts with a CO2 removal entity to remove employees' average annual CO2 in excess of a sustainable lifestyle and exchanges ownership proportional to the amount of employees' CO2 removed.
